(19) United States
(12) Patent Application Publication
(10) Pub. No.: US 2001/0012482 A1
(43) Pub. Date: Aug. 9, 2001

(54) Dumping device for concrete blocks, bricks, paving stones or the like

(76) Inventor: Sylvain Vezina, St-Hubert (CA)

Correspondence Address: J. Rodman Steele, Jr., Akerman Senterfitt, 222 Lakeview Ave., Suite 400, Post Office Box 3188, West Palm Beach, FL, 33402-3188, US

(21) Appl. No.: 09/748,728

(22) Filed: Dec. 22, 2000

(30) Foreign Application Priority Data
Dec. 23, 1999 (CA) 2,293,752

(51) Int. Cl. B65G 65/34

(52) U.S. Cl. 414/419

(57) ABSTRACT

There is described a dumping device for use in a system for tumbling products, such as concrete blocks, bricks, paving stones or the like loaded in successive layers on a pallet. The dumping device comprise a pallet receiving structure pivotally mounted on a fixed frame, the structure including a tilting and a movable floor that receives the pallet with the layers of products thereon. The structure is first tilted to a predetermined angle corresponding to a product unloading position; thereafter, the floor is pushed intermittently so that the layers are unloaded in succession layer by layer onto a product conveying station and, thereafter, to a tumbler. Sensors are provided to indicate the presence or absence of the products at the conveying station and to give a signal to intermittently actuate the floor.

### FIELD OF THE INVENTION

The present invention relates to a dumping device for unloading products, such as concrete blocks, bricks, paving stones or the like loaded in successive vertical layers on a pallet onto a conveying station whereby the products may be brought to a tumbling station.

### BACKGROUND OF THE INVENTION

It is well known to place in a tumbling machine (or tumbler) products such as concrete blocks, bricks, paving stones or the like in order to give them an aged appearance. The conventional way of achieving such tumbling is to first dump the products onto a conveyor which brings the products to the tumbler. The products are usually loaded in successive layers onto a pallet which is placed onto a structure that pivots so that the products may be dumped on the conveyor. With such systems, some problems exist such as the occurrence that the entire stack of layers may be discharged onto the conveyor, thus resulting in damages to the equipment due to the mass being unloaded at the same time. Also, the height of the platform is a major factor causing the platform or floor that receives the loaded pallet to be relatively high for the loader vehicle placing the pallet onto the platform.

### OBJECTS AND STATEMENT OF THE INVENTION

The present invention therefore pertains to a dumping device which overcomes the above-described problems.

This is achieved by providing a device wherein the stack of products is placed on the floor of a load receiving structure which is lower than the product sliding surface used to slide the products to a conveying station and wherein the structure is first pivoted to an unloading angle and, after having reached this position, the floor of the structure is pushed intermittently so that the layers of products may be unloaded in succession layer by layer.

The present invention therefore relates to a dumping device for use in a tumbling system which comprises:

a fixed frame;

a product receiving structure pivotably mounted on the fixed frame; the structure including a tilting frame and a movable floor adapted to receive the pallet with the layers of products thereon and to be movably displaced on the tilting frame;

actuatable means mounted on the fixed frame and engaging the structure to tilt the structure relative to the fixed frame from a product loaded pallet receiving position to a product unloading position;

pusher means mounted on the structure for displacing the floor when the structure has reached a predetermined tilt position whereby a first layer of the products is caused to slide onto the slide surface and the conveyor; and

means actuating the pusher means to intermittently move the floor each time a layer of products has been unloaded and conveyed so that the layers may be unloaded in succession layer by layer.

In one form of the invention, the tilting frame of the structure includes a pair of laterally spaced tracks, each track having an upper end pivotally connected to an upper end of the fixed frame adjacent the slide surface.

In another preferred form of the invention, the tilting frame of the structure includes a pair of side plates connected to the floor so as to be movable therewith.

In another form of the invention, the actuating means are responsive to detectors which are located adjacent the conveyor to indicate the presence or absence of products on the conveyor.

Other objects and further scope of applicability of the present invention will become apparent from the detailed description given hereinafter. It should be understood, however, that this detailed description, while indicating preferred embodiments of the invention, is given by way of illustration only, since various changes and modifications within the spirit and scope of the invention will become apparent to those skilled in the art.

### BRIEF DESCRIPTION OF THE DRAWINGS

FIG. 1 is a top plan view of a system used when products are to be tumbled;

FIG. 2 is a side elevation of a tumbling device made in accordance with the present invention shown adjacent a first conveying station;

FIG. 3 is a side elevation showing the pivotable structure of the tumbling device in the product loading position;

FIG. 4 is a side elevation similar to FIG. 3 showing the structure in the product unloading angle;

FIGS. 5 and 6 are side elevational views showing two different angle positions of the pivotable structure prior to unloading;

FIG. 7 is a side view similar to FIGS. 5 and 6, showing the pivotable structure in an unloading operation;

FIG. 8 is a side view showing the movable floor on the pivotable structure for the unloading operation; and

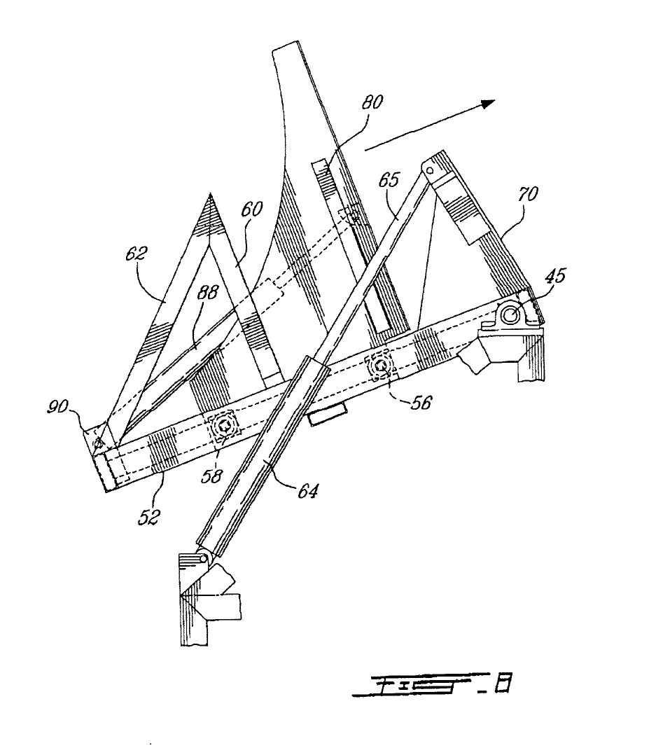

FIG. 9 is a top plan view of an arrangement of four tumbling devices made in accordance with present invention with product detector means adjacent the conveyor.

### DESCRIPTION OF PREFERRED EMBODIMENTS

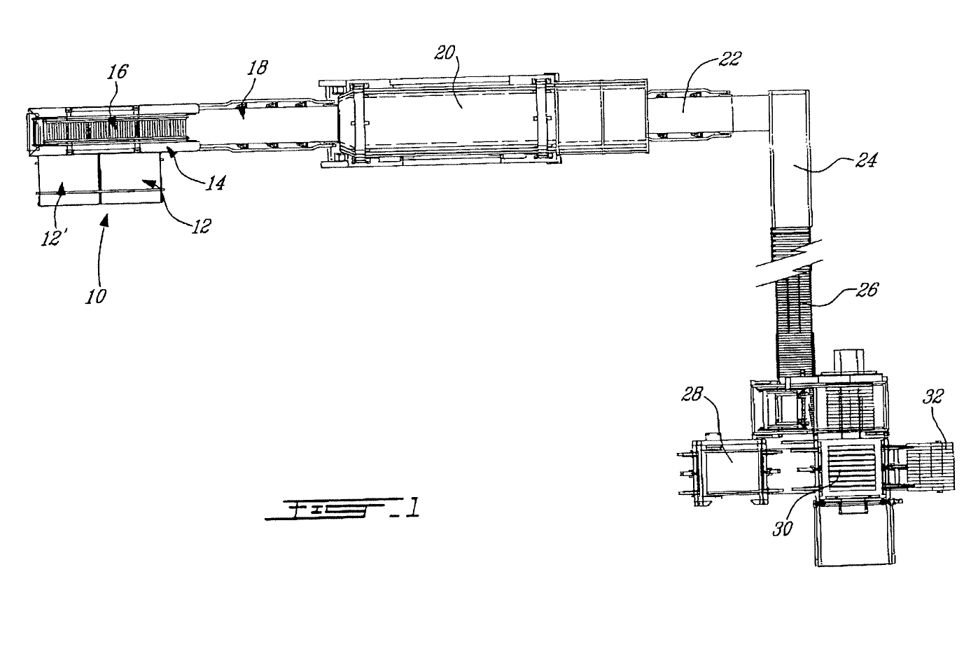

Referring to FIG. 1, there is shown the various stations required whenever it is wished to tumble products, such as concrete blocks, bricks, paving stones or the like, in order to provide them with an aged appearance. Products which are stacked in vertical layers onto a pallet are brought to a loading station 10, consisting in the present illustration of two dumping devices 12 and 12′ which are adapted to unload the products onto a slide surface 14 and a conveyor 16. The dumped products are conveyed to a second conveyor 18 which drops the products into a tumbler 20 which, through rotation, provides an aged appearance to the products and from which they are retrieved and placed on two successive conveyors 22 and 24. At station 26, the products are manually placed prior to being finally stacked at a final station that comprises a pallet receiving station 28, an automatic cubing system 30 and a product loaded pallet conveyor 32.

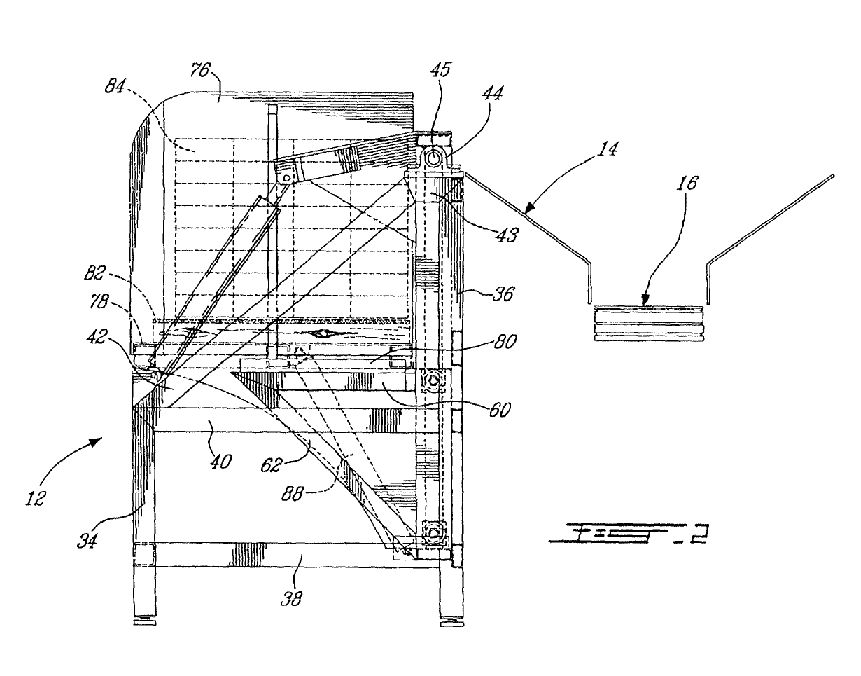

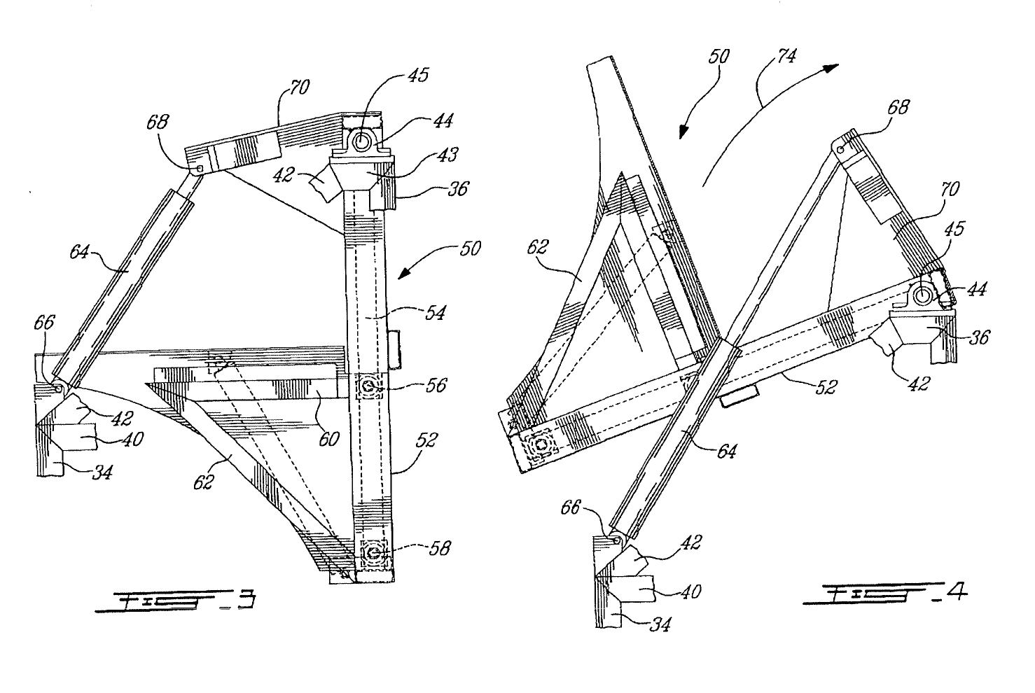

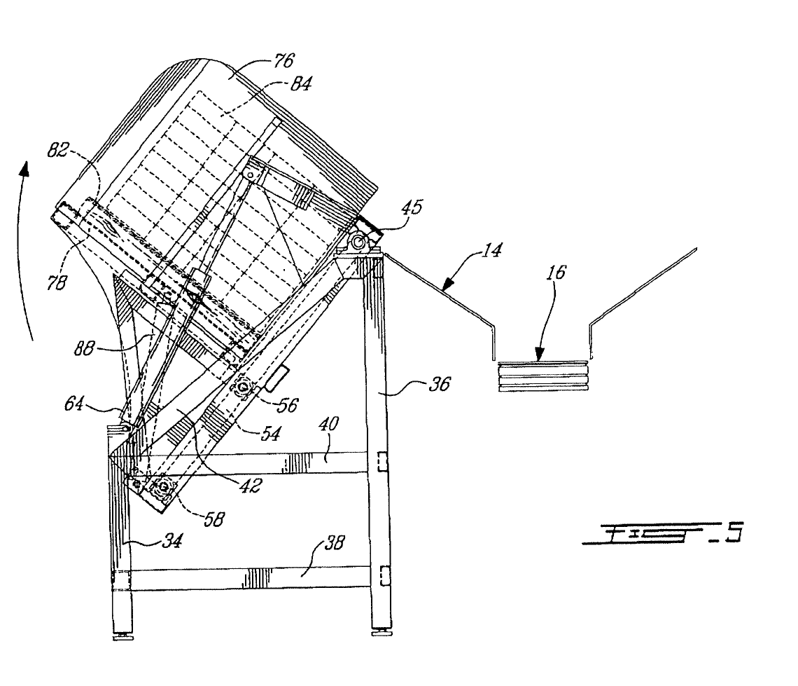

Referring to FIG. 2, a tumbling device in accordance with the present invention, generally denoted 12, is illustrated and comprises a fixed frame formed of four vertical frame members (two being shown as 34, 36,) four horizontal frame members (two being shown as 38, 40) and two oblique frame members (one being shown as 42). At the top of the frame members 36 and 42, extends a horizontal frame member 43 on which rests a pair of pivot brackets (one being shown as 44) which are located adjacent the uppermost edge of the slide surface 14. Referring to FIG. 3, a pivotable structure, generally denoted 50, is mounted to the fixed frame by means of a horizontal rod 45 that extends through the pivot brackets 44. The tilting frame of the pivotable structure comprises a pair of laterally spaced members 52, each inner face of which defines a track 54 in which are adapted to roll a pair of cam followers 56 and 58. The lower part of the frame members 52 includes a load bearing structure consisting of members 60 and 62. An hydraulically operated cylinder 64 has its lower end 66 pivotally mounted to the fixed frame while its opposite upper end 68 is pivotally mounted to a plate extension 70 which, in turn, is pivotably mounted on rod 45. As can be seen in FIG. 4, extending piston 65 of cylinder 64 causes the structure 50 to pivot about the axis of rod 45 in the manner indicated by the arrow 74. A similar arrangement of cylinder 64 and plate 70 is provided on the other side of the pivotable structure.

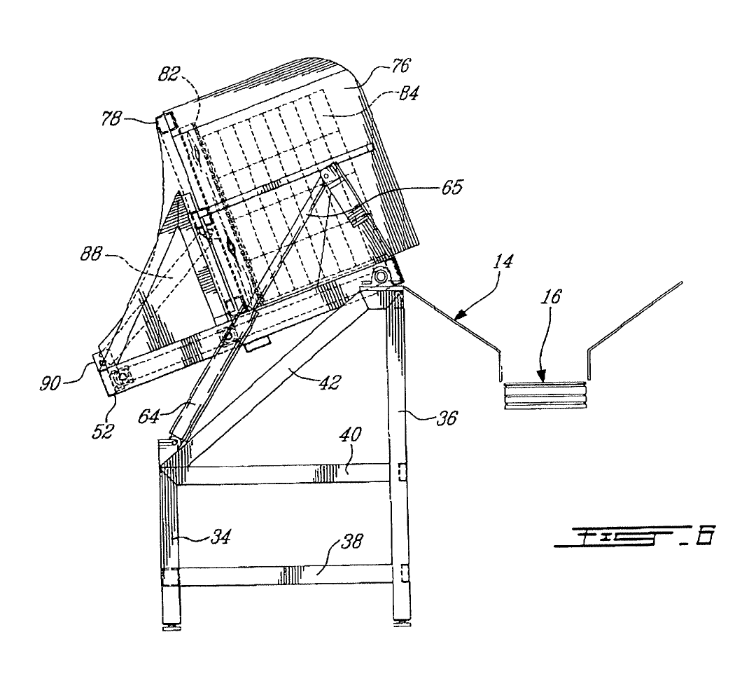

The pivotable structure 50 also includes a pair of laterally spaced side plates (one of which is shown as 76 in FIG. 5) which are located on either side of platform 78; these plates are connected to the cam followers 56 and 58. The outer wall of each side plate 76 displays a rectangular shaped member 80 which contacts and rests on the frame member 60 of the tilling frame when the dumping device is in the load receiving position shown in FIG. 3.

As can be seen in FIG. 5, a pallet 82 on which are stacked layers of products 84, is placed on the floor 78. This floor is adapted to be moved through its connection to the rollers 56 and 58 in tracks 54 by means of an hydraulically operated cylinder 88 which has its upper end connected to the floor 78 and its lower end connected to a bracket 90 secured to the frame member 52 (see FIG. 6).

The operation of the dumping device so far described will now be given.

A pallet 82 with vertically stacked layers of products 84 is brought by a loader vehicle and placed on the floor 78 of the dumping device when in the position shown in FIG. 2 where the floor rests horizontally on the pivotable structure. The weight of the load is taken by the side plate members 80 resting on the top face of the opposite horizontal frame members 60. Through the actuation of cylinder 64 (see FIG. 4), the tilting frame 50 is pivoted in the direction of arrow 74 until it reaches a pre-determined angle, approximately 70°. At this angle shown in FIG. 6, the products are ready to slide onto the slide surface 14 and the conveyor 18. It is to be noted that other means to pivot the structure is also possible such as telescopic jacks or other systems which will amplify the travel of the cylinders such as levers, pulleys, chains and sprockets, gears, cams, etc. It is also possible to use hydraulic or electric motors which would actuate gears chains and sprockets. These systems, although possible, appear to be more expensive.

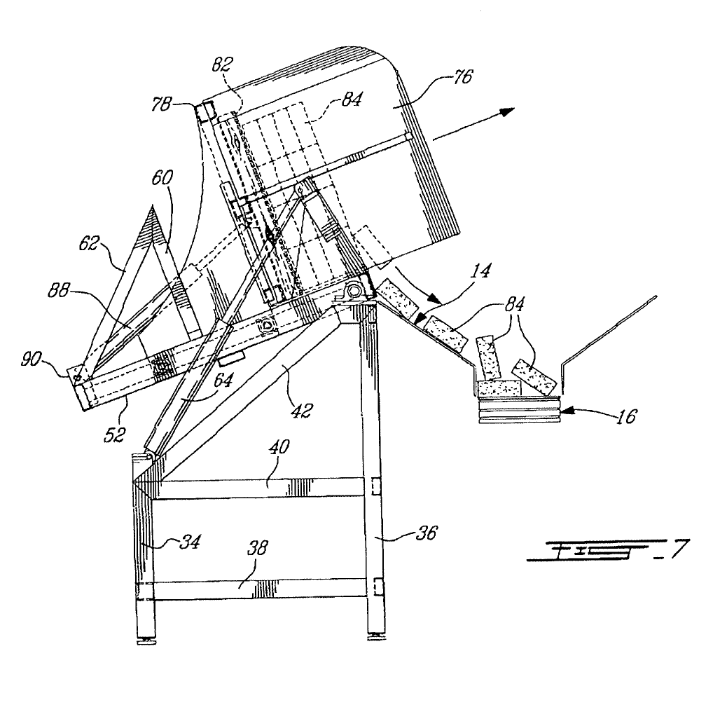

Referring to FIG. 7, once the predetermined tilt angle of the structure is reached, cylinder 88 is actuated to push the floor so that the top layer of products may slide onto the slide surface 14 and subsequently onto the conveyor 16.

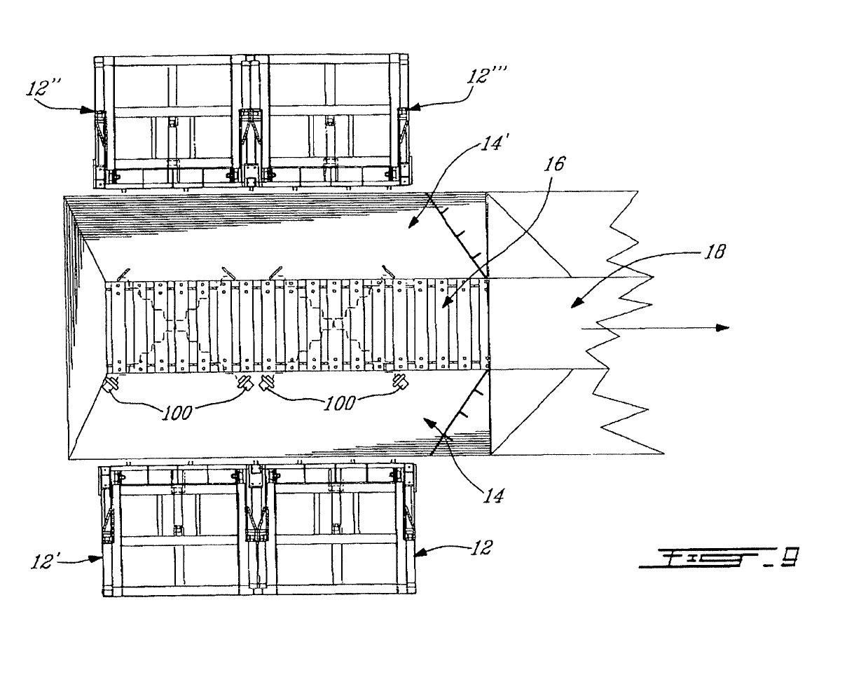

Means are provided adjacent the conveyor to detect the presence or absence of products on the conveyor and are shown in FIG. 9 where a system of four dumping devices 12, 12′, 12″ and 12′″ is illustrated. In one preferred form, the detection system consists of a series of photocells 100 for sensing the presence of products on the conveyor 16. Whenever the absence of products on the conveyor is noted, a signal is sent to operate the cylinder 88 to push the floor a given distance so that a second layer of products may be caused to slide off onto the slide surface 14 and the conveyor 16. And, so on, so that the floor is intermittently moved to unload the stack of products.

Although the invention has been described above with respect to one specific form, it will be evident to a person skilled in the art that it may be refined and modified in various ways. For example, a series of limit switches can be used to detect the movement of the lifting floor; other switches could also be used to indicate whether the floor is in a horizontal position or in an inclined position. Also, in order to execute a total unloading when the structure has reached the angle of 70° as described above, a proximity switch may be used to detect this angle and to stop the hydraulic jacks. Thereafter, the floor begins to move and, as soon as the first layer of blocks slides onto the conveyor, the photocells detect the presence of blocks and the floor is immediately stopped. As soon as the photocells do not detect the presence of blocks during a predetermined time interval, the floor continues to move until other blocks are detected on the conveyor and, similarly, until a limit which detects the end of the movement of the floor. Thereafter, the floor lowers and actuates limits switches at the bottom, during which the structure pivots and another limit switch detects that the floor has reached its horizontal position. It will be understood that, in the case of FIG. 9 where more than one tumbling devices is used, the limit switches will operate in succession passing the information to a following dumping device which will operate in the manner described above. Therefore, the present invention should not be limited in interpretation, except by the terms of the following claims.

1. In a system for tumbling products, such as concrete blocks, bricks, paving stones or the like, loaded in successive layers on a pallet, a dumping device for unloading said products onto a conveying station including an inclined slide surface for sliding said products onto a conveyor; said dumping device comprising:
a fixed frame;
a product receiving structure pivotably mounted on said fixed frame; said structure including a tilting frame and a movable floor adapted to receive said pallet with said layers of products thereon and to be movably displaced on said tilting frame;
actuatable means mounted on said fixed frame and engaging said structure to tilt said structure relative to said fixed frame from a product loaded pallet receiving position to a product unloading position;
pusher means mounted on said structure for displacing said floor when said structure has reached a predetermined tilt position whereby a first layer of said products is caused to slide onto said slide surface and said conveyor; and
means actuating said pusher means to intermittently move said floor each time a layer of products has been unloaded and conveyed so that said layers may be unloaded in succession layer by layer.

2. A dumping device as defined in claim 1, wherein said tilting frame of said structure includes a pair of laterally spaced tracks disposed on either side of said floor; each said track having an upper end pivotally connected to an upper end of said fixed frame adjacent said slide surface.

3. A dumping device as defined in claim 2, wherein said structure further includes roller means for connecting said floor to said tracks to allow movement of said floor relative to said tilting frame.

4. A dumping device as defined in claim 3, wherein said tilting frame of said structure includes a pair of side plates laterally spaced from one another and connected to said floor so as to be movable therewith.

6. A dumping device as defined in claim 1, wherein said actuatable means consists of an hyraulically operated cylinder having one end connected to said fixed frame and an opposite end connected to said tilting frame.

5. A dumping device as defined in claim 4, wherein said tilting frame of said structure includes a load bearing member mounted on each said track and wherein each said side plate has an outer wall displaying an abutment for contacting said load bearing member when said tilting frame is in said pallet receiving position.

7. A dumping device as defined in claim 1, wherein said pusher means consists of an hydraulically operated cylinder having one end connected to said tilting frame and an opposite end connected to said floor.

8. A dumping device as defined in claim 1, wherein said means actuating said pusher means consist of means for detecting the presence of products on said conveyor.

9. A dumping device as defined in claim 8, wherein said detecting means consist of photocells located adjacent said conveyor.
